(19) United States
(12) Patent Application Publication
(10) Pub. No.: US 2026/0229382 A1
(43) Pub. Date: Aug. 6, 2026

(54) ELECTRIC WIRE

(71) Applicant: Sumitomo Electric Industries, Ltd., Osaka-shi, Osaka (JP)

(72) Inventors: Tomoaki IKEDA, Osaka-shi, Osaka (JP); Mitsuyasu OGAWA, Osaka-shi, Osaka (JP); Koji KASUYA, Osaka-shi, Osaka (JP); Akihito HOSHIMA, Osaka-shi, Osaka (JP); Kenta MATSUOKA, Osaka-shi, Osaka (JP)

(73) Assignee: Sumitomo Electric Industries, Ltd., Osaka-shi, Osaka (JP)

(21) Appl. No.: 19/151,429

(22) PCT Filed: Oct. 31, 2023
(86) PCT No.: PCT/JP2023/039220

§ 371 Date: Jul. 28, 2025

(30) Foreign Application Priority Data
Feb. 10, 2023 (JP) 2023-018992

(51) Int. Cl. H01B 1/02; H01B 13/00

(52) U.S. Cl. CPC H01B 1/02; H01B 13/0036

(57) ABSTRACT

An electrical wire comprising a core wire and a coating that covers the core wire, wherein the core wire contains iron as a main component, the coating includes a first layer, the first layer contains copper as a main component, and the first layer contains carbon at 10.5-20.5 ppm on a mass basis.

### TECHNICAL FIELD

The present disclosure relates to an electric wire. The present application claims priority based on Japanese Patent Application No. 2023-018992 filed on Feb. 10, 2023. The entire contents of the Japanese Patent Application are incorporated herein by reference.

### BACKGROUND ART

Conventionally, an electric wire including a core wire and a coating film that coats the core wire has been used in a vehicle or the like (PTL 1).

### CITATION LIST

### Patent Literature

PTL 1: Japanese Patent Laying-Open No. 2004-207080

### SUMMARY OF INVENTION

An electric wire according to one embodiment of the present disclosure is an electric wire comprising: a core wire; and a coating film that coats the core wire, wherein
the core wire includes iron as a main component,
the coating film includes a first layer,
the first layer includes copper as a main component, and
the first layer includes 10.5 ppm or more and 20.5 ppm or less of carbon on a mass basis.

### BRIEF DESCRIPTION OF DRAWINGS

FIG. 1 is a schematic perspective view of an electric wire according to one embodiment of the present disclosure.

FIG. 2 is a schematic cross sectional view along II-II of FIG. 1.

FIG. 3 is a flowchart of a method of manufacturing the electric wire according to one embodiment of the present disclosure.

FIG. 4 shows an enlarged photograph of a transverse cross section of an electric wire according to a sample 101.

FIG. 5 shows an enlarged photograph of a transverse cross section of an electric wire according to a sample 1.

FIG. 6 shows an enlarged photograph of the transverse cross section of the electric wire according to sample 101 after being exposed to an environment of 250° C. for one hour and being cooled in an environment of 25° C. for one hour.

FIG. 7 shows an enlarged photograph of a region VII in FIG. 6.

FIG. 8 shows an enlarged photograph of the transverse cross section of the electric wire according to sample 1 after being exposed to an environment of 250° C. for one hour and being cooled in an environment of 25° C. for one hour.

FIG. 9 is a schematic perspective view of an electric wire of a sample cut in an evaluation test 2.

FIG. 10 is a schematic cross sectional view illustrating an evaluation method in evaluation test 2.

FIG. 11 is a schematic cross sectional view of an exemplary electric wire of a sample corresponding to an evaluation criterion A′ in evaluation test 2.

FIG. 12 is a schematic cross sectional view of an exemplary electric wire of a sample corresponding to an evaluation criterion B′ in evaluation test 2.

FIG. 13 is a schematic cross sectional view of another exemplary electric wire of a sample corresponding to evaluation criterion B′ in evaluation test 2.

FIG. 14 is a schematic perspective view illustrating an evaluation method in an evaluation test 3.

### DETAILED DESCRIPTION

### [Problem to be Solved by the Present Disclosure]

An electric wire may be heated when processing the electric wire, when current flows through the electric wire, and when the electric wire is used in a high-temperature environment. Therefore, in the case where the electric wire includes a core wire including iron as a main component and a copper layer that coats the core wire, when the temperature of the electric wire is increased in response to the heating, stress is applied to the copper layer due to a difference between the thermal expansion coefficient of the core wire and the thermal expansion coefficient of the copper layer and due to the core wire being generally harder than the copper layer. Moreover, in the case where the temperature of the electric wire is increased in response to the heating, a crystal grain is grown in the copper layer, with the result that the crystal grain may become a starting point of cracking of the copper layer when strong stress is externally applied to the electric wire. Therefore, in the conventional electric wire, in response to the heating, a crack may be generated at an interface of the copper layer on the core wire side due to the stress and the growth of the crystal grain, with the result that the copper layer may be likely to be detached with a location of the generated crack serving as a starting point of detachment. Therefore, it has been required to suppress the coating film from being detached when stress is externally applied to the electric wire exposed to a high temperature.

Thus, an object of the present disclosure is to provide an electric wire in which a coating film can be suppressed from being detached when stress is externally applied to the electric wire exposed to a high temperature.

### Advantageous Effect of the Present Disclosure

According to the present disclosure, it is possible to provide an electric wire in which a coating film can be suppressed from being detached when stress is externally applied to the electric wire exposed to a high temperature.

### DESCRIPTION OF EMBODIMENTS

First, embodiments of the present disclosure will be listed and described.

An electric wire according to one embodiment of the present disclosure is an electric wire comprising: a core wire; and a coating film that coats the core wire, wherein
the core wire includes iron as a main component,
the coating film includes a first layer,
the first layer includes copper as a main component, and
the first layer includes 10.5 ppm or more and 20.5 ppm or less of carbon on a mass basis.

According to the present disclosure, it is possible to provide an electric wire in which a coating film can be suppressed from being detached when stress is externally applied to the electric wire exposed to a high temperature.

In [1], the first layer may include 11.5 ppm or more of the carbon on the mass basis. Thus, it is possible to provide the electric wire in which the coating film can be further suppressed from being detached when stress is externally applied to the electric wire exposed to a high temperature.

In [1] or [2], the first layer may include 16.5 ppm or less of the carbon on the mass basis. Thus, it is possible to provide the electric wire in which the coating film can be further suppressed from being detached when stress is externally applied to the electric wire exposed to a high temperature.

In any one of [1] to [3], the first layer may include 0.35 ppm or more and 1.30 ppm or less of hydrogen on the mass basis. Thus, it is possible to provide the electric wire in which the coating film can be further suppressed from being detached when stress is externally applied to the electric wire exposed to a high temperature.

In [4], the first layer may include 0.51 ppm or more of the hydrogen on the mass basis. Thus, it is possible to provide the electric wire in which the coating film can be further suppressed from being detached when stress is externally applied to the electric wire exposed to a high temperature.

In [4] or [5], the first layer may include 1.12 ppm or less of the hydrogen on the mass basis. Thus, it is possible to provide the electric wire in which the coating film can be further suppressed from being detached when stress is externally applied to the electric wire exposed to a high temperature.

In any one of [1] to [6], the first layer may include 2.41 ppm or more and 5.62 ppm or less of oxygen on the mass basis. Thus, it is possible to provide the electric wire in which the coating film can be further suppressed from being detached when stress is externally applied to the electric wire exposed to a high temperature.

In [7], the first layer may include 3.01 ppm or more of the oxygen on the mass basis. Thus, it is possible to provide the electric wire in which the coating film can be further suppressed from being detached when stress is externally applied to the electric wire exposed to a high temperature.

In [7] or [8], the first layer may include 5.01 ppm or less of the oxygen on the mass basis. Thus, it is possible to provide the electric wire in which the coating film can be further suppressed from being detached when stress is externally applied to the electric wire exposed to a high temperature.

In any one of [1] to [9], the first layer may include 0.22 ppm or more and 0.65 ppm or less of sulfur on the mass basis. Thus, it is possible to provide the electric wire in which the coating film can be further suppressed from being detached when stress is externally applied to the electric wire exposed to a high temperature.

In any one of [1] to [10], the first layer may have crystal grains, and
an average grain size of the crystal grains may be 0.5 μm or more and 2 μm or less. Thus, it is possible to provide the electric wire in which the coating film can be further suppressed from being detached when stress is externally applied to the electric wire exposed to a high temperature.

In any one of [1] to [11], the coating film may further include a second layer,
the second layer may be located between the core wire and the first layer,
the second layer may include nickel as a main component, and
a thickness of the second layer may be 0.3 nm or more and 40.3 nm or less. Thus, it is possible to provide the electric wire in which the coating film can be further suppressed from being detached when stress is externally applied to the electric wire exposed to a high temperature.

In any one of [1] to [12], a diameter of the core wire may be 0.10 mm or more and 0.20 mm or less. Thus, it is possible to provide the electric wire in which the coating film can be further suppressed from being detached when stress is externally applied to the electric wire exposed to a high temperature.

In any one of [1] to [13], a thickness of the first layer may be 0.04 mm or more and 0.06 mm or less. Thus, it is possible to provide the electric wire in which the coating film can be further suppressed from being detached when stress is externally applied to the electric wire exposed to a high temperature.

In any one of [1] to [14], the core wire may include stainless steel or carbon steel. Thus, it is possible to provide the electric wire in which the coating film can be further suppressed from being detached when stress is externally applied to the electric wire exposed to a high temperature.

### Details of Embodiments of the Present Disclosure

The following describes one embodiment (hereinafter, referred to as “the present embodiment”) of the present disclosure. However, the present embodiment is not limited thereto. In the present specification, the expression “A to B” represents a range of lower to upper limits (i.e., A or more and B or less), and when no unit is indicated for A and a unit is indicated only for B, the unit of A is the same as the unit of B.

When a compound or the like is expressed by a chemical formula in the present specification and an atomic ratio is not particularly limited, it is assumed that all the conventionally known atomic ratios are included, and the atomic ratio should not be necessarily limited only to one in the stoichiometric range.

### First Embodiment: Electric Wire

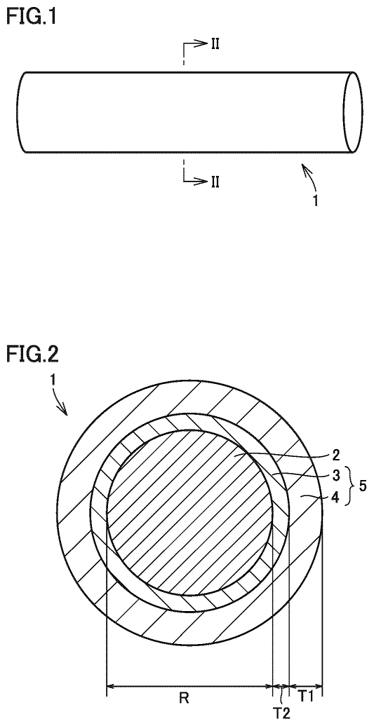

An electric wire 1 according to one embodiment of the present disclosure will be described with reference to FIGS. 1 and 2.

One embodiment of the present disclosure (hereinafter, also referred to as the “present embodiment”) is directed to an electric wire 1 including: a core wire 2; and a coating film 5 that coats core wire 2, wherein
core wire 2 includes iron as a main component,
coating film 5 includes a first layer 4,
first layer 4 includes copper as a main component, and
first layer 4 includes 10.5 ppm or more and 20.5 ppm or less of carbon on a mass basis.

According to the present disclosure, it is possible to provide electric wire 1 in which coating film 5 can be suppressed from being detached when stress is externally applied to electric wire 1 exposed to a high temperature. This is presumably due to the following reason.

During processing of the electric wire, the coating film of the electric wire may be heated. Moreover, since the electric wire generates heat when current flows through the electric wire, the coating film of the electric wire may be heated. Moreover, the electric wire may be used in a high-temperature environment, and the coating film of the electric wire may be heated. When the coating film is heated, crystal grains of the coating film are grown. As a result, when columnar crystals are formed in the coating film in a film thickness direction of the coating film, a crystal grain boundary extends in the film thickness direction, thereby facilitating generation of a crack in the film thickness direction. The core wire and the coating film that coats the core wire are likely to be detached with the crack serving as a starting point of detachment.

In electric wire 1 according to the present embodiment, coating film 5 includes first layer 4, first layer 4 includes the copper as the main component, and first layer 4 includes 10.5 ppm or more and 20.5 ppm or less of the carbon on the mass basis. Thus, the grain growth of the crystal grains each including the copper is likely to be suppressed. As a result, the grain boundary of the crystal grains can be suppressed from being extending in first layer 4 in the film thickness direction, with the result that a crack is less likely to be generated in the film thickness direction. Therefore, core wire 2 and coating film 5 that coats core wire 2 can be suppressed from being detached with the crack serving as a starting point of detachment.

Therefore, according to the present disclosure, it is possible to provide electric wire 1 in which coating film 5 can be suppressed from being detached when stress is externally applied to electric wire 1 exposed to a high temperature.

### <<Core Wire>>

### <Composition of Core Wire>

Electric wire 1 includes core wire 2. Core wire 2 includes the iron as the main component. Here, the “iron” means “iron element”. Further, the expression “core wire 2 includes the iron as the main component” means that “core wire 2 includes 50 mass % or more of the iron”. The lower limit of the content ratio of the iron in core wire 2 can be 51 mass % or more, 52 mass % or more, 53 mass % or more, or 73 mass % or more. The upper limit of the content ratio can be 100 mass % or less, 99 mass % or less, or 98 mass % or less. The content ratio can be 51 mass % or more and 100 mass % or less, 52 mass % or more and 99 mass % or less, or 53 mass % or more and 98 mass % or less.

The content ratio of the iron in core wire 2 can be found by the following method. That is, first, 1 part by mass of the core wire is dissolved with 99 parts by mass of a mixed acid of hydrochloric acid and nitric acid (hydrochloric acid: nitric acid=3:1 in mass ratio), thereby preparing a solution. Next, the solution is subjected to ICP (Inductively Coupled Plasma) emission spectrometry using “iCAP6300” (provided by Thermo Fisher Scientific). The ICP emission spectrometry is performed by performing a quantitative analysis onto an element (except for a C element, a S element, and an element not to be analyzed by the ICP emission spectroscopy) detected at 5 mg/L or more after a collective qualitative analysis. In this way, the content of the iron in core wire 2 can be found. It should be noted that it has been confirmed that there is no variation in measurement results even when a measurement location is freely selected as long as the measurement is performed using the same electric wire 1.

Core wire 2 may include stainless steel or carbon steel. Thus, alloying with first layer 4 is facilitated to proceed, thereby further improving the detachment resistance of coating film 5 when stress is externally applied to electric wire 1 exposed to a high temperature.

Here, the “stainless steel” means steel in which a content ratio of iron is 74 mass % or less, a content ratio of nickel is 8 mass % or more, and a content ratio of chromium is 18 mass % or more. The stainless steel can include an inevitable impurity in addition to the iron, the nickel, and the chromium. Examples of the inevitable impurity include carbon (0.01 mass % or more and 0.08 mass % or less), silicon (0.1 mass % or more and 1.0 mass % or less), manganese (0.1 mass % or more and 2.0 mass % or less), phosphorus (0.01 mass % or more and 0.045 mass % or less), sulfur (0.01 mass % or more and 0.03 mass % or less), and the like. Examples of a material of the stainless steel include SUS304. It should be noted that here, the “iron” means “iron element”. The “nickel” means “nickel element”. The “chromium” means “chromium element”. The “carbon” means “carbon element”. The “silicon” means “silicon element”. The “manganese” means “manganese element”. The “phosphorus” means “phosphorus element”. The “sulfur” means “sulfur element”.

The “carbon steel” means a steel in which a content ratio of iron is 97.9 mass % or more and 99.8 mass % or less and a content ratio of carbon is 0.02 mass % or more and 2.14 mass % or less. The carbon steel can include an inevitable impurity in addition to the iron and the carbon. Examples of the inevitable impurity include sulfur (0.01 mass % or more and 0.03 mass % or less), phosphorus (0.001 mass % or more and 0.01 mass % or less), silicon (0.01 mass % or more and 0.05 mass % or less), and the like. Examples of a material of the carbon steel include a piano wire. It should be noted that here, the “iron” means “iron element”. The “carbon” means “carbon element”. The “sulfur” means “sulfur element”. The “phosphorus” means “phosphorus element”. The “silicon” means “silicon element”.

Each of the content ratio of the carbon in core wire 2, the content ratio of the chromium in core wire 2, the content ratio of the nickel in core wire 2, the content ratio of the silicon in core wire 2, the content ratio of the manganese in core wire 2, the content ratio of the phosphorus in core wire 2, and the content ratio of the sulfur in core wire 2 can be found in the same manner as in the method of measuring the “content ratio of the iron in core wire 2”.

It has been confirmed that there is no variation in measurement results even when a measurement location is freely selected as long as the measurement is performed using the same electric wire 1.

### <Structure of Core Wire>

Diameter R of core wire 2 may be 0.10 mm or more and 0.20 mm or less. Thus, disconnection or cracking is less likely to occur when stress is applied from the outside of electric wire 1, thereby further improving the detachment resistance of coating film 5 when stress is externally applied to electric wire 1 exposed to a high temperature. The lower limit of diameter R may be 0.10 mm or more, 0.12 mm or more, 0.14 mm or more, or 0.15 mm or more. The upper limit of diameter R may be 0.20 mm or less, 0.19 mm or less, or 0.17 mm or less. Diameter R may be 0.12 mm or more and 0.19 mm or less, or 0.14 mm or more and 0.17 mm or less.

Diameter R of core wire 2 can be found by the following method. That is, first, electric wire 1 of 20 mm as obtained by cutting it along a plane perpendicular to the long-side direction thereof is embedded in a resin. Next, one of the cut surfaces of electric wire 1 embedded in the resin is subjected to preliminary finishing by mechanical polishing, and a cross section polisher (CP) is applied thereto using an Ar ion beam under the below-described conditions, thereby obtaining a polished cut surface. Next, the polished cut surface is subjected to CP-SEM (Scanning Electron Microscopy) using a high-resolution scanning electron microscope “SU8020” provided by Hitachi High-Tech Corporation, thereby obtaining a 500× image such that the whole of the polished cut surface is included in one visual field. Next, in the image, the length of the longest line segment is found among line segments that each connect any one point on the outer periphery of core wire 2 and one point located on the outer periphery. Next, for each of any other four points, the length of the longest line segment is found in the same manner. By calculating the average value of the lengths of these longest line segments, diameter R can be specified.

(Conditions for CP)
Acceleration voltage: 1.0 kV
Inclination: 0°

### <<Coating Film>>

Electric wire 1 includes coating film 5 that coats core wire 2. The thickness of coating film 5 may be 41 μm or more and 65 μm or less. When the thickness of coating film 5 is less than 41 μm, the electric conductivity of coating film 5 tends to be decreased. When the thickness of coating film 5 is more than 65 μm, wire drawability in a subsequent step tends to be decreased. The thickness of coating film 5 may be 45 μm or more and 63 μm or less, or 50 μm or more and 60 μm or less.

The thickness of coating film 5 means the average value of the thickness of coating film 5 in the transverse cross section of electric wire 1. Hereinafter, detailed explanation including a measurement method therefor will be further described. Specifically, first, microscope images of any five transverse cross sections of electric wire 1 are obtained by a scanning electron microscope (SEM). Next, any five points are selected on the outer periphery (outermost surface) of electric wire 1 in each of the above-described images, the shortest distance from the outer periphery to core wire 2 is found at each of the points, and the shortest distance is defined as the thickness of coating film 5. An average value is calculated from a value found by measuring the thicknesses of coating film 5 at a total of 25 locations, and the average value can be regarded as the thickness of coating film 5. It should be noted that when there is an apparently abnormal value in the above measurement, the average value is calculated with the abnormal value being excluded. When there are abnormal values at three or more locations, the measurement is further alternatively performed the same number of times as the number of the abnormal values and numerical values accordingly obtained are used to calculate the average value.

It has been confirmed that there is no variation in measurement results even when a measurement location is freely selected as long as the measurement is performed using the same electric wire 1.

### <First Layer>

(Composition of First Layer)

Coating film 5 includes first layer 4. Here, first layer 4 may be in contact with the outer peripheral surface of core wire 2, or may not be in contact with the outer peripheral surface of core wire 2. When first layer 4 is not in contact with the outer peripheral surface of core wire 2, a below-described second layer 3, another layer, or both of them may be present between core wire 2 and first layer 4. Coating film 5 may consist only of first layer 4 or may consist only of first layer 4 and below-described second layer 3. Further, first layer 4 includes the copper as the main component. Thus, first layer 4 can provide electric conductivity to electric wire 1. Here, the “copper” means “copper element”. Further, the expression “first layer 4 includes the copper as the main component” means that “first layer 4 includes 99 mass % or more of the copper”. The lower limit of the content ratio of the copper in first layer 4 may be 99.99 mass % or more, 99.991 mass % or more, or 99.992 mass % or more. The upper limit of the content ratio can be 99.999 mass % or less, 99.998 mass % or less, or 99.997 mass % or less. The content ratio can be 99.99 mass % or more and 99.999 mass % or less, 99.991 mass % or more and 99.998 mass % or less, or 99.992 mass % or more and 99.997 mass % or less.

The content ratio of the copper in first layer 4 can be found by the following method. That is, the content ratio of the copper in first layer 4 can be found by performing a D-SIMS (Dynamic Secondary Ion Mass Spectrometry) analysis under below-described conditions. When performing the D-SIMS analysis, due to the principle of performing the D-SIMS analysis, the content ratio of the copper in first layer 4 needs to be specified by finding the average value of the content ratios of the copper in an intermediate portion thereof while sputtering the target sample from the outermost layer (in other words, while shaving it). For example, when analyzing the copper in first layer 4 having a thickness of 50 μm (in other words, 0.050 mm), the content ratio of the copper in first layer 4 needs to be specified by finding the average value of the content ratios in the portion (in other words, the intermediate portion) sandwiched between a first imaginary plane at a distance of 15 μm from an interface of the first layer on the surface side and a second imaginary plane at a distance of 35 μm from the interface of the first layer on the surface side. It should be noted that each of the “content ratio of the carbon in first layer 4”, the “content ratio of the hydrogen in first layer 4”, the “content ratio of the oxygen in first layer 4”, and the “content ratio of the sulfur in first layer 4”, which will be described later, can also be found in the same manner.

(Conditions for D-SIMS)
Apparatus: “IMS6f” provided by CAMECA
Primary ion species: Cs⁺
Acceleration voltage: 15 kV
Analysis region: 30 μmφ

It has been confirmed that there is no variation in measurement results even when a measurement location and a width between the first imaginary plane and the second imaginary plane are freely selected as long as the measurement is performed using the same electric wire 1.

First layer 4 includes 10.5 ppm or more and 20.5 ppm or less of the carbon on the mass basis. Thus, a pinning effect is exerted to retard the movement of the grain boundary, with the result that the growth of the crystal grains in the first layer is likely to be suppressed. Therefore, it is possible to improve the detachment resistance of coating film 5 when stress is externally applied to electric wire 1 exposed to a high temperature. The lower limit of the content ratio of the carbon in first layer 4 may be 11.5 ppm or more, 12.0 ppm or more, or 12.3 ppm or more on the mass basis. The upper limit of the content ratio of the carbon in first layer 4 may be 16.5 ppm or less, 15.5 ppm or less, or 14.4 ppm or less on the mass basis. The content ratio of the carbon in first layer 4 may be 11.5 ppm or more and 16.5 ppm or less, 12.0 ppm or more and 15.5 ppm or less, or 12.3 ppm or more and 14.4 ppm or less on the mass basis. It should be noted that here, the “carbon” means “carbon element”.

First layer 4 may include 0.35 ppm or more and 1.30 ppm or less of the hydrogen on the mass basis. Thus, the pinning effect is exerted to retard the movement of the grain boundary, with the result that the growth of the crystal grains in the first layer is likely to be suppressed. Therefore, it is possible to further improve the detachment resistance of coating film 5 when stress is externally applied to electric wire 1 exposed to a high temperature. The lower limit of the content ratio of the hydrogen in first layer 4 may be 0.35 ppm or more, 0.51 ppm or more, or 0.67 ppm or more on the mass basis. The upper limit of the content ratio of the hydrogen in first layer 4 may be 1.30 ppm or less, 1.12 ppm or less, or 0.94 ppm or less on the mass basis. The content ratio of the hydrogen in first layer 4 may be 0.51 ppm or more and 1.12 ppm or less, or 0.67 ppm or more and 0.94 ppm or less on the mass basis. It should be noted that here, the “hydrogen” means “hydrogen element”.

First layer 4 may include 2.41 ppm or more and 5.62 ppm or less of the oxygen on the mass basis. Thus, the pinning effect is exerted to retard the movement of the grain boundary, with the result that the growth of the crystal grains in the first layer is likely to be suppressed. Therefore, it is possible to further improve the detachment resistance of coating film 5 when stress is externally applied to electric wire 1 exposed to a high temperature. The lower limit of the content ratio of the oxygen in first layer 4 may be 2.41 ppm or more, 3.01 ppm or more, or 3.12 ppm or more on the mass basis. The upper limit of the content ratio of the oxygen in first layer 4 may be 5.62 ppm or less, 5.01 ppm or less, or 4.32 ppm or less on the mass basis. The content ratio of the oxygen in first layer 4 may be 3.01 ppm or more and 5.01 or less, or may be 3.12 ppm or more and 4.32 ppm or less. It should be noted that here, the “oxygen” means “oxygen element”.

First layer 4 may include 0.22 ppm or more and 0.65 ppm or less of the sulfur on the mass basis. Thus, the pinning effect is exerted to retard the movement of the grain boundary, with the result that the growth of the crystal grains in the first layer is likely to be suppressed. Therefore, it is possible to further improve the detachment resistance of coating film 5 when stress is externally applied to electric wire 1 exposed to a high temperature. The lower limit of the content ratio of the sulfur in first layer 4 may be 0.22 ppm or more, 0.25 ppm or more, or 0.29 ppm or more on the mass basis. The upper limit of the content ratio of the sulfur in first layer 4 may be 0.65 ppm or less, 0.55 ppm or less, or 0.45 ppm or less on the mass basis. The content ratio of the sulfur in first layer 4 may be 0.25 ppm or more and 0.55 ppm or less, or 0.29 ppm or more and 0.45 ppm or less on the mass basis. It should be noted that here, the “sulfur” means “sulfur element”.

First layer 4 can include an inevitable impurity as long as electric wire 1 has both the electric conductivity and the detachment resistance. Examples of the inevitable impurity include nitrogen, phosphorus, and silicon. The content ratio of the inevitable impurity can be found in the same manner as in the method of measuring the content ratio of the copper in first layer 4.

### (Structure of First Layer)

Thickness T1 of first layer 4 may be 0.04 mm or more and 0.06 mm or less. Thus, heat is facilitated to be diffused between core wire 2 and coating film 5, thereby further improving the detachment resistance of coating film 5 when stress is externally applied to electric wire 1 exposed to a high temperature. The lower limit of thickness T1 of first layer 4 may be 0.04 mm or more, 0.045 mm or more, or 0.050 mm or more. The upper limit of thickness T1 of first layer 4 may be 0.06 mm or less, 0.058 mm or less, or 0.056 mm or less. Thickness T1 of first layer 4 may be 0.045 mm or more and 0.058 mm or less, or 0.050 mm or more and 0.056 mm or less.

Thickness T1 of first layer 4 can be found in the same manner as in the method of measuring the thickness of coating film 5 except for the following point: “when first layer 4 is present on the outermost surface of coating film 5, the shortest distance from the outer periphery to an interface of first layer 4 on the core wire 2 side is found and the shortest distance is defined as thickness T1 of first layer 4, whereas when first layer 4 is not present on the outermost surface of coating film 5, the shortest distance from the interface of first layer 4 on the surface side to the interface of first layer 4 on the core wire 2 side is found and the shortest distance is defined as thickness T1 of first layer 4”.

It has been confirmed that there is no variation in measurement results even when a measurement location is freely selected as long as the measurement is performed using the same electric wire 1.

First layer 4 may have the crystal grains, and the average grain size of the crystal grains may be 0.5 μm or more and 2 μm or less. Thus, it becomes difficult for the grain boundary to reach core wire 2 from the surface of coating film 5 even when the grain growth occurs, thereby further improving the detachment resistance of coating film 5 when stress is externally applied to electric wire 1 exposed to a high temperature. The lower limit of the average grain size of the crystal grains may be 0.5 μm or more, 0.7 μm or more, or 0.9 μm or more. The upper limit of the average grain size of the crystal grains may be 2 μm or less, 1.4 μm or less, or 1.1 μm or less. The average grain size of the crystal grains may be 0.7 μm or more and 1.4 μm or less, or 0.9 μm or more and 1.1 μm or less.

The average grain size of the crystal grains can be found by the following method. That is, first, electric wire 1 of 20 mm as obtained by cutting it along a plane perpendicular to the long-side direction thereof is embedded in a resin. Next, one of the cut surfaces of electric wire 1 embedded in the resin is subjected to preliminary finishing by mechanical polishing, and a cross section polisher (CP) is applied thereto using an Ar ion beam under the below-described conditions, thereby obtaining a polished cut surface. Next, the polished cut surface is subjected to CP-SEM (Scanning Electron Microscopy) using a high-resolution scanning electron microscope “SU8020” provided by Hitachi High-Tech Corporation so as to obtain a 5000× image such that the whole of the polished cut surface is included in one visual field. Next, in the image, each of the grain sizes of the individual crystal grains is calculated in accordance with the following formula (1) and the average value of the grain sizes is defined as the average grain size of the crystal grains.

$$( Grain Size of Crystal Grain ) = \{ ( Width of Crystal Grain ) + ( Height of Crystal Grain ) \} / 2 \qquad ( 1 )$$

Here, the “Width of Crystal Grain” means the maximum distance between two points located at the outer edge of the measured crystal grain with an imaginary line passing through the two points being perpendicular to the thickness direction of the coating film. The “Height of Crystal Grain” means the maximum distance between two points located at the outer edge of the measured crystal grain with an imaginary line passing through the two points being parallel to the thickness direction of the coating film. The number of the crystal grains measured is any ten in one visual field of the same first layer, and the number of the visual fields is 20. It should be noted that one visual field is a rectangle having a length of 12 μm×a width of 9.6 μm.

(Conditions for CP)
Acceleration voltage: 1.0 kV
Inclination: 0°

It has been confirmed that there is no variation in measurement results even when a measurement location is freely selected as long as the measurement is performed using the same electric wire 1.

### <Second Layer>

(Composition of Second Layer)

Coating film 5 may further include second layer 3, second layer 3 may be located between core wire 2 and first layer 4, and second layer 3 may include the nickel as the main component. Thus, when heat diffusion occurs, the iron element of core wire 2, the copper element of coating film 5, and the nickel element of coating film 5 are metal-bonded, thereby further improving the detachment resistance of coating film 5 when stress is externally applied to electric wire 1 exposed to a high temperature. Here, as long as second layer 3 is located between core wire 2 and first layer 4, second layer 3 may be in contact with the outer peripheral surface of core wire 2 or may not be in contact with the outer peripheral surface of core wire 2. When second layer 3 is not in contact with the outer peripheral surface of core wire 2, the other layer described later can be present between core wire 2 and second layer 3. Further, as long as second layer 3 is located between core wire 2 and first layer 4, first layer 4 may be in contact with the outer peripheral surface of second layer 3 or may not be in contact with the outer peripheral surface of second layer 3. When first layer 4 is not in contact with the outer peripheral surface of second layer 3, the other layer described later may be present between second layer 3 and first layer 4. Here, the “nickel” means “nickel element”. Further, the expression “second layer 3 includes the nickel as the main component” means that “second layer 3 includes 90 mass % or more of the nickel”. The lower limit of the content ratio of the nickel in second layer 3 can be 91 mass % or more, 92 mass % or more, 93 mass % or more, or 99 mass % or more. The upper limit of the content ratio can be 100 mass % or less, 99 mass % or less, or 98 mass % or less. The content ratio can be 91 mass % or more and 100 mass % or less, 92 mass % or more and 99 mass % or less, or 93 mass % or more and 98 mass % or less.

The content ratio of the nickel in second layer 3 can be found by the following method. That is, the content ratio can be found in the following procedure.

(A1) A transverse cross section of electric wire 1 is obtained by cutting electric wire 1 along the plane perpendicular to the long-side direction thereof. Next, the transverse cross section is subjected to micro-sampling processing using a focused ion beam (FIB) provided by “Quanta 3D” from FEI company, USA. The micro-sampling processing includes rough processing and finishing processing. The rough processing is performed under a condition of 30 kV, and the finishing processing is performed under a condition of 8 kV.

(B1) Any one observation visual field in the form of a rectangle of 0.1 μm×0.09 μm is set at a magnification of 2 million times for a region of second layer 3 of the transverse cross section having been through the micro-sampling processing, thereby obtaining an image of the observation visual field.

(C1) The content ratio of the nickel in the observation visual field is measured by performing an EDX analysis onto the image under a condition of 200 kV using “JEM-2100F” provided by JEOL.

(D1) By performing the above (B1) and the above (C1) for each of any other four observation fields, the content ratio of the nickel in the observation field is measured.

(E1) The content ratio of the nickel in second layer 3 can be found by calculating the average value of the content ratios of the nickel in the total of the five observation fields.

It has been confirmed that there is no variation in measurement results even when a measurement location is freely selected as long as the measurement is performed using the same electric wire 1.

Second layer 3 can include an inevitable impurity as long as electric wire 1 has the detachment resistance. Examples of the inevitable impurity include carbon, silicon, and sulfur. The content ratio of the inevitable impurity can be found in the same manner as in the method of measuring the content ratio of the nickel in second layer 3.

(Structure of Second Layer)

Thickness T2 of second layer 3 may be 0.3 nm or more and 40.3 nm or less. Thus, since the iron element of the core wire and the copper element or nickel element of the coating film are metal-bonded when heat diffusion occurs, it is possible to further improve the detachment resistance of coating film 5 when stress is externally applied to electric wire 1 exposed to a high temperature. The lower limit of thickness T2 of second layer 3 may be 0.3 nm or more, 5 nm or more, or 10 nm or more. The upper limit of thickness T2 of second layer 3 may be 40.3 nm or less, 30 nm or less, or 20 nm or less. Thickness T2 of second layer 3 may be 5 nm or more and 30 nm or less, and may be 10 nm or more and 20 nm or less.

Thickness T2 of second layer 3 can be found in the same manner as in the method of measuring the thickness of coating film 5 except for the following point: “the shortest distance from an interface of second layer 3 on the surface side to an interface of second layer 3 on the core wire 2 side is found and the shortest distance is defined as thickness T2 of second layer 3”.

It has been confirmed that there is no variation in measurement results even when a measurement location is freely selected as long as the measurement is performed using the same electric wire 1.

### <Other Layer>

Coating film 5 may further include the other layer. Examples of the other layer include a Ni—Cu layer, a Fe—Ni₃ layer, and the like.

The thickness of the other layer can be found in the same manner as in the method of measuring the thickness of coating film 5 except for the following point: “when the other layer is located on the outermost surface of coating film 5, the shortest distance from the outer periphery to an interface of the other layer on the core wire 2 side is found and the shortest distance is defined as the thickness of the other layer, whereas when the other layer is not located on the outermost surface of coating film 5, the shortest distance from an interface of the other layer on the surface side to the interface of the other layer on the core wire 2 side is found and the shortest distance is defined as the thickness of the other layer”.

### Second Embodiment: Method of Manufacturing Electric Wire

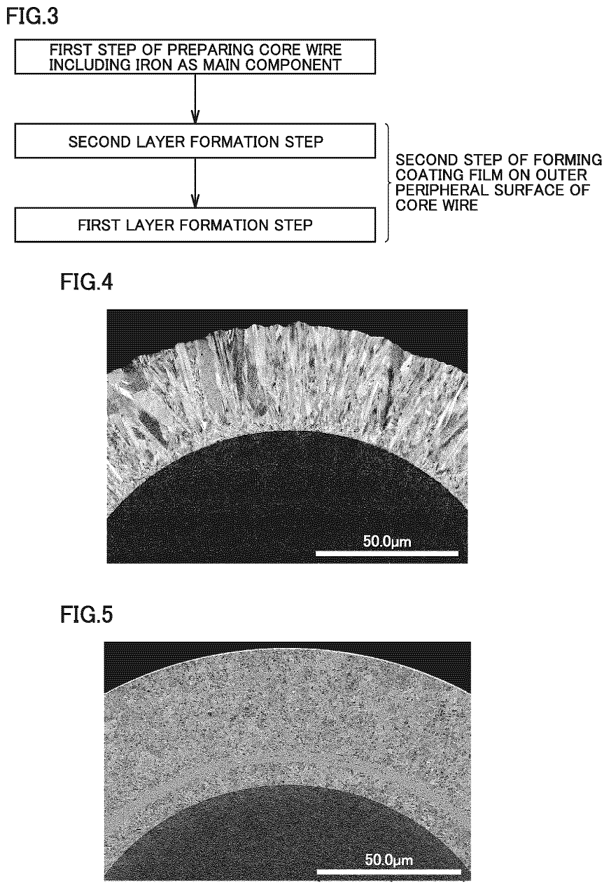

A method of manufacturing an electric wire according to the present embodiment will be described with reference to FIG. 3. FIG. 3 is a flowchart of the method of manufacturing an electric wire according to one embodiment of the present disclosure. As shown in FIG. 3, the method of manufacturing an electric wire according to the present embodiment is a method of manufacturing the electric wire according to the first embodiment, the method including:
a first step of preparing the core wire including the iron as the main component; and
a second step of forming the coating film on the outer peripheral surface of the core wire, wherein
the second step includes a first layer formation step of forming the first layer on the outer peripheral surface of the core wire. In the first layer formation step, an electrolytic plating bath including 1 mg/L or more and 15 mg/L or less of an additive agent is used. Moreover, in the method of manufacturing the electric wire according to the present embodiment, the second step can further include a second layer formation step of forming the second layer on the outer peripheral surface of the core wire before the first layer formation step.

### <<First Step>>

In the first step, the core wire including the iron as the main component is prepared. The first step of preparing the core wire can be performed, for example, by preparing the core wire of the stainless steel including the iron as the main component, the carbon steel including the iron as the main component, or the like. It should be noted that in the first step, a step of degreasing the outer peripheral surface of the core wire and performing cleaning with water after the degreasing may be performed.

### <<Second Step>>

In the second step, the coating film is formed on the outer peripheral surface of the core wire. The second step includes the “first layer formation step” of forming the first layer on the outer peripheral surface of the core wire. The second step can further include the “second layer formation step” of forming the second layer on the outer peripheral surface of the core wire before the “first layer formation step”. The second step can include a step of forming another layer in addition to the “first layer coating step” or in addition to the “first layer coating step” and the “second layer coating step”. The other layer can be formed by a conventional method.

### <Second Layer Formation Step>

In the second layer formation step, the second layer is formed on the outer peripheral surface of the core wire before the “first layer formation step”. The second layer formation step can be performed, for example, by forming the second layer on the outer peripheral surface of the core wire by electrolytic plating using a Woods bath.

### <First Layer Formation Step>

In the first layer formation step, the first layer is formed on the outer peripheral surface of the core wire. The first layer formation step can be performed, for example, by forming the first layer on the outer peripheral surface of the core wire by electrolytic plating using copper sulfate plating. It should be noted that after the first layer formation step, a step of cleaning the outer peripheral surface of the first layer with water may be performed.

In the first layer formation step, an electrolytic plating bath including an additive agent is used. Here, the additive agent means a polymer, a leveler, and a brightener. In the electrolytic plating bath, each of the content of the polymer, the content of the leveler, and the content of the brightener is 1 mg/L or more and 15 mg/L or less. Thus, the content ratio of the carbon, the content ratio of the hydrogen, and the content ratio of the sulfur in the first layer can be adjusted to fall within desired ranges, thereby improving the detachment resistance of the coating film when stress is externally applied to the electric wire exposed to a high temperature. This has been newly found as a result of diligent study by the present inventors. It should be noted that the electrolytic plating bath may be a copper sulfate plating bath.

Examples of the polymer include polyethylene glycol (PEG). Examples of the leveler include bis(3-sulfopropyl) disulfide (SPS). Examples of the brightener include Janus Green B (JGB).

The lower limit of the content ratio of the additive agent in the electrolytic plating may be 1.5 mg/L or more, 2 mg/L or more, or 3 mg/L or more. The upper limit of the content ratio of the additive agent in the electrolytic plating may be 13 mg/L or less, 10 mg/L or less, or 8 mg/L or less. The content ratio of the additive agent in the electrolytic plating may be 1.5 mg/L or more and 13 mg/L or less, 2 mg/L or more and 10 mg/L or less, or 3 mg/L or more and 8 mg/L or less.

### EXAMPLES

Hereinafter, the present invention will be described in detail with reference to examples, but the present invention is not limited thereto.

### <<Production of Electric Wire>>

Each of electric wires according to samples 1 to 19 and samples 101 to 106 was produced in the following manner.

### <First Step>

First, the “degreasing step” was performed onto an outer peripheral surface of a core wire having a configuration shown in Table 3 under the below-described conditions using a degreasing liquid (“ACE CLEAN 220” (trademark) provided by Okuno Chemical Industries), and then the “water cleaning step” was performed under the below-described condition. It should be noted that when “Stainless Steel” or “Carbon Steel” is described in the column “Stainless Steel/Carbon Steel” in Table 3, it means that the core wire includes “stainless steel” or “carbon steel”.

(Conditions for Degreasing Step)
Temperature: 50° C.
Time: 10 seconds

(Condition for Water Cleaning Step)
Immersion Time: 10 seconds

### <Second Layer Formation Step (Second Step)>

Next, the second layer formation step was performed by performing electrolytic plating onto the outer peripheral surface of the core wire after the water cleaning step under the conditions of temperature and current density as shown in Table 1 using a Woods bath having composition and pH shown in Table 1. It should be noted that a time for the electrolytic plating was a time until the thickness of the second layer became as shown in Table 3. Further, when “-” is described in all the columns of the column “Second Layer Formation Step” in Table 1, it means that the second layer formation step was not performed.

### <First Layer Formation Step (Second Step)>

Next, the first layer formation step is performed, onto the outer peripheral surface of the second layer formed in the second layer formation step, using a copper sulfate plating (electrolytic plating) bath having composition and pH shown in Table 2 under the conditions of temperature and current density as shown in Table 2, thereby forming a first layer. It should be noted that a time for the electrolytic plating was a time until the thickness of the first layer became as shown in Table 4.

Next, the outer peripheral surface of the first layer was subjected to the water cleaning step under the following condition.

(Condition for Water Cleaning Step)
Immersion Time: 10 seconds

TABLE 1

| | Second Step | | | | |
|---|---|---|---|---|---|
| | Second Layer Formation Step | | | | |
| | Composition of Woods Bath | | | | |
| | Nickel | Hydrochloric | | | Current |
| Sample | Chloride | Acid | | Temperature | Density |
| No. | [g/L] | [mL/L] | pH | [° C.] | [A/dm²] |
| 1 | 240 | 125 | 0.8 | 23 | 40 |
| 2 | 240 | 125 | 0.8 | 23 | 40 |
| 3 | 240 | 125 | 0.8 | 23 | 40 |
| 4 | 240 | 125 | 0.8 | 23 | 40 |
| 5 | 240 | 125 | 0.8 | 23 | 40 |
| 6 | 240 | 125 | 0.8 | 23 | 40 |
| 7 | 240 | 125 | 0.8 | 23 | 40 |
| 8 | 240 | 125 | 0.8 | 23 | 40 |
| 9 | 240 | 125 | 0.8 | 23 | 40 |
| 10 | 240 | 125 | 0.8 | 23 | 40 |
| 11 | 240 | 125 | 0.8 | 23 | 40 |
| 12 | 240 | 125 | 0.8 | 23 | 40 |
| 13 | — | — | — | — | — |
| 14 | 240 | 125 | 0.8 | 23 | 40 |
| 15 | 240 | 125 | 0.8 | 23 | 40 |
| 16 | 240 | 125 | 0.8 | 23 | 40 |
| 17 | 240 | 125 | 0.8 | 23 | 40 |
| 18 | 240 | 125 | 0.8 | 23 | 40 |
| 19 | 240 | 125 | 0.8 | 23 | 40 |
| 101 | 240 | 125 | 0.8 | 23 | 40 |
| 102 | 240 | 125 | 0.8 | 23 | 40 |
| 103 | 240 | 125 | 0.8 | 23 | 40 |
| 104 | 240 | 125 | 0.8 | 23 | 40 |
| 105 | 240 | 125 | 0.8 | 23 | 40 |
| 106 | 240 | 125 | 0.8 | 23 | 40 |

TABLE 2

| | Second Step | | | | | | | | |
|---|---|---|---|---|---|---|---|---|---|
| | First Layer Formation Step | | | | | | | | |
| | Composition of Copper Sulfate Bath | | | | | | | | |
| | Copper | | | | | | | | |
| | Sulfate | Sulfuric | Chlorine | | | | | | Current |
| Sample | Pentahydrate | Acid | Ion | PEG | SPS | JGB | | Temperature | Density |
| No. | [g/L] | [g/L] | [mg/L] | [mg/L] | [mg/L] | [mg/L] | pH | [° C.] | [A/dm²] |
| 1 | 220 | 50 | 60 | 7 | 7 | 8 | 0 | 50 | 60 |
| 2 | 220 | 50 | 60 | 3 | 4 | 4 | 0 | 50 | 60 |
| 3 | 220 | 50 | 60 | 8 | 7 | 8 | 0 | 50 | 60 |
| 4 | 220 | 50 | 60 | 8 | 8 | 8 | 0 | 50 | 60 |
| 5 | 220 | 50 | 60 | 6 | 6 | 7 | 0 | 50 | 60 |
| 6 | 220 | 50 | 60 | 1.5 | 2 | 2 | 0 | 50 | 60 |
| 7 | 220 | 50 | 60 | 13 | 12 | 12 | 0 | 50 | 60 |
| 8 | 220 | 50 | 60 | 3 | 4 | 3 | 0 | 50 | 60 |
| 9 | 220 | 50 | 60 | 1.5 | 1.5 | 1.5 | 0 | 50 | 60 |
| 10 | 220 | 50 | 60 | 13 | 13 | 13 | 0 | 50 | 60 |
| 11 | 220 | 50 | 60 | 6 | 5 | 6 | 0 | 50 | 60 |
| 12 | 220 | 50 | 60 | 7 | 6 | 8 | 0 | 50 | 60 |
| 13 | 220 | 50 | 60 | 7 | 6 | 8 | 0 | 50 | 60 |
| 14 | 220 | 50 | 60 | 1.1 | 8.5 | 1.1 | 0 | 50 | 60 |
| 15 | 220 | 50 | 60 | 14.5 | 2.2 | 14.9 | 0 | 50 | 60 |
| 16 | 220 | 50 | 60 | 9 | 1 | 12 | 0 | 50 | 60 |
| 17 | 220 | 50 | 60 | 2 | 15 | 6 | 0 | 50 | 60 |
| 18 | 220 | 50 | 60 | 14.8 | 14.9 | 14.9 | 0 | 50 | 60 |
| 19 | 220 | 50 | 60 | 1 | 1 | 1 | 0 | 50 | 60 |
| 101 | 220 | 50 | 60 | 16.5 | 14 | 10 | 0 | 50 | 60 |
| 102 | 220 | 50 | 60 | 14 | 16.5 | 10 | 0 | 50 | 60 |
| 103 | 220 | 50 | 60 | 10 | 10 | 16.5 | 0 | 50 | 60 |
| 104 | 220 | 50 | 60 | 0 | 5 | 5 | 0 | 50 | 60 |
| 105 | 220 | 50 | 60 | 5 | 0 | 1 | 0 | 50 | 60 |
| 106 | 220 | 50 | 60 | 5 | 5 | 0 | 0 | 50 | 60 |

With the above steps, the electric wires according to samples 1 to 19 and samples 101 to 106 having the configurations shown in Tables 3 and 4 were produced.

### <<Evaluation on Property of Electric Wire>>

<Composition of First Layer>

For each of the electric wires according to samples 1 to 19 and samples 101 to 106, the content ratio of the copper in the first layer was found by the method described in the first embodiment. Obtained results are shown in the column “Cu [ppm]” in Table 4. For each of the electric wires according to samples 1 to 19 and samples 101 to 106, the content ratio of the carbon in the first layer was found by the method described in the first embodiment. Obtained results are shown in the column “C [ppm]” in Table 4. Moreover, for each of the electric wires according to samples 1 to 19 and samples 101 to 106, the content ratio of the hydrogen in the first layer was found by the method described in the first embodiment. t. Obtained results are shown in the column “H [ppm]” in Table 4. Moreover, for each of the electric wires according to samples 1 to 19 and samples 101 to 106, the content ratio of the oxygen in the first layer was found by the method described in the first embodiment. Obtained results are shown in the column “O [ppm]” in Table 4. Moreover, for each of the electric wires according to samples 1 to 19 and samples 101 to 106, the content ratio of the sulfur in the first layer was found by the method described in the first embodiment. Obtained results are shown in the column “S [ppm]” in Table 4.

### <Average Grain Size of Crystal Grains>

For each of the electric wires according to samples 1 to 19 and samples 101 to 106, the average grain size of the crystal grains in the first layer was found by the method described in the first embodiment. Obtained results are shown in the column “Average Grain Size of Crystal Grains [μm]” in Table 4. It should be noted that FIG. 4 shows an enlarged photograph of a transverse cross section of the electric wire according to sample 101. On the other hand, FIG. 5 shows an enlarged photograph of a transverse cross section of the electric wire according to sample 1.

### <Composition of Second Layer>

For each of the electric wires according to samples 1 to 19 and samples 101 to 106, the content ratio of the nickel in the second layer was found by the method described in the first embodiment. Obtained results are shown in the column of “Ni [mass %]” in Table 3. It should be noted that when “-” is described in all the columns of the column “Second Layer” in Table 3, it means that the second layer is not present.

### <Thickness of Coating Film>

For each of the electric wires according to samples 1 to 19 and samples 101 to 106, the thickness of the coating film was found by the method described in the first embodiment. Obtained results are shown in the column “Thickness of Coating Film [mm]” in Table 4.

### <Evaluation Test 1>

First, each of the electric wires according to samples 1 to 19 and samples 101 to 106 was exposed to an environment at 250° C. for one hour. Next, each of the electric wires according to samples 1 to 19 and samples 101 to 106 was cooled in an environment of 25° C. for one hour. Next, for each of the electric wires according to samples 1 to 19 and samples 101 to 106, the average grain size of the crystal grains in the first layer was found by the method described in the first embodiment. Obtained results are shown in the column “Evaluation Test 1” in Table 4. It should be noted that evaluation criteria are as follows.

### (Evaluation Criteria for Evaluation Test 1)

A: the average grain size of the crystal grains is 3 μm or more and 10 μm or less.
B: the average grain size of the crystal grains is more than 10 μm.

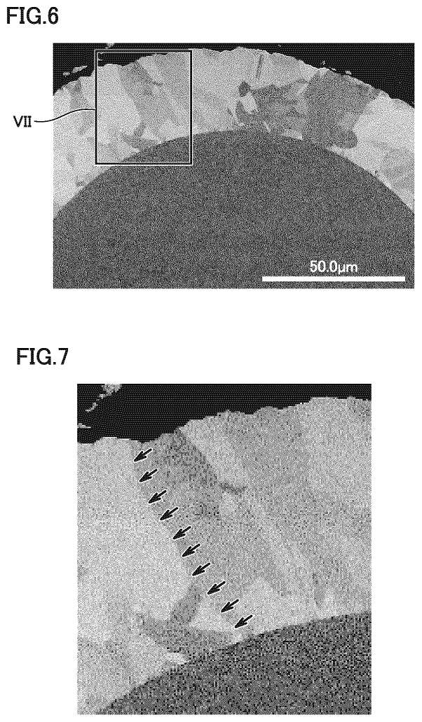

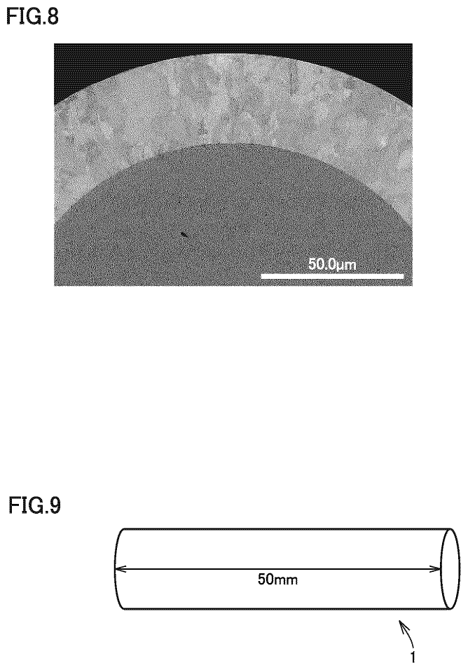

It should be noted that FIG. 6 shows an enlarged photograph of a transverse cross section of the electric wire according to sample 101 after being exposed to the environment of 250° C. for one hour and being cooled in the environment of 25° C. for one hour as described above. FIG. 7 shows an enlarged photograph of a region VII in FIG. 6. In FIG. 7, a location indicated by each of arrows indicates a location at which the grain boundary of the crystal grains extends in the film thickness direction. FIG. 8 shows an enlarged photograph of a transverse cross section of the electric wire according to sample 1 after being exposed to the environment of 250° C. for one hour and being cooled in the environment of 25° C. for one hour as described above. As the average grain size of the crystal grains is larger, a crack is more likely to be generated and detachment of the coating film is more likely to occur with the crack serving as a starting point of detachment, and therefore in evaluation test 1, a large average grain size of the crystal grains means that the detachment resistance of the coating film when stress is externally applied to the electric wire exposed to a high temperature has been decreased.

### <Evaluation Test 2>

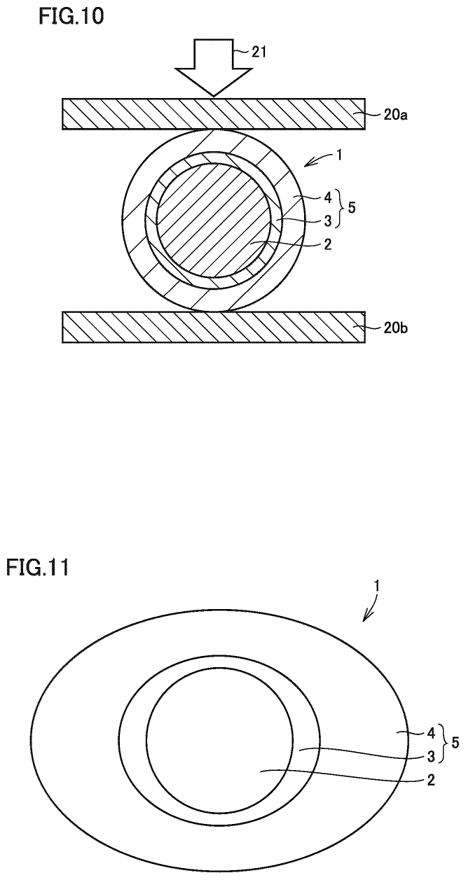

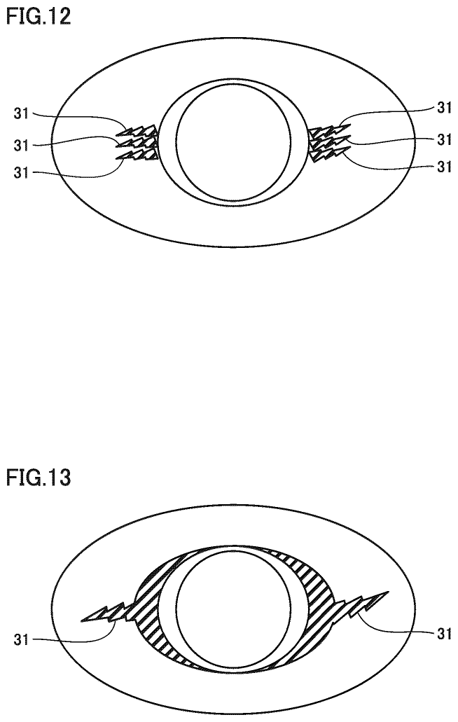

A method of an evaluation test 2 will be described below with reference to FIGS. 9 to 13. FIG. 9 is a schematic perspective view of an electric wire 1 of a sample cut in an evaluation test 2. FIG. 10 is a schematic cross sectional view illustrating an evaluation method in evaluation test 2. FIG. 11 is a schematic cross sectional view of an exemplary electric wire of a sample corresponding to an evaluation criterion A′ in evaluation test 2. FIG. 12 is a schematic cross sectional view of an exemplary electric wire of a sample corresponding to an evaluation criterion B′ in evaluation test 2. FIG. 13 is a schematic cross sectional view of another exemplary electric wire of a sample corresponding to evaluation criterion B′ in evaluation test 2. First, each of electric wires 1 according to samples 1 to 19 and samples 101 to 106 was exposed to an environment of 250° C. for one hour. Next, each of electric wires 1 according to samples 1 to 19 and samples 101 to 106 was cooled in an environment of 25° C. for one hour. Next, each of electric wires 1 according to samples 1 to 19 and samples 101 to 106 was cut to have a length of 50 mm as shown in FIG. 9. Next, as shown in FIG. 10, electric wire 1 cut to have the length of 50 mm was sandwiched between stainless steel plates 20a, 20b. Next, a pressure of 6000 N was applied to electric wire 1 in a direction of arrow 21 from stainless steel plate 20a with stainless steel plate 20b being fixed, so as to reduce the diameter of the transverse cross section of electric wire 1 by 40%. Next, 150× SEM images of the outer peripheral surface of first layer 4 of electric wire 1 of each of samples 1 to 19 and samples 101 to 106 after the application of the pressure were obtained, and the outer peripheral surface of first layer 4 of electric wire 1 of each of samples 1 to 19 and samples 101 to 106 was evaluated in accordance with the evaluation criteria described below. Obtained results are shown in the column “Evaluation Test 2” in Table 4. It should be noted that in evaluation test 2, evaluation criterion A′ described later specifically means the state shown in FIG. 11, and evaluation criterion B′ described later specifically means the state shown in each of FIGS. 12 and 13. Moreover, when a crack is generated at the interface of the first layer on the core wire side, the detachment of the coating film is likely to occur with the crack serving as a starting point of detachment, and therefore, when the crack is generated, it means that the detachment resistance of the coating film when stress is externally applied to the electric wire exposed to a high temperature has been decreased even though the detachment has not occurred yet.

### <Evaluation Test 3>

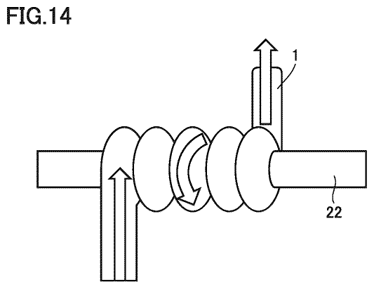

A method of an evaluation test 3 will be described below with reference to FIG. 14. FIG. 14 is a schematic perspective view illustrating an evaluation method in evaluation test 3. First, each of electric wires 1 according to samples 1 to 19 and samples 101 to 106 was exposed to an environment of 250° C. for one hour. Next, each of electric wires 1 according to samples 1 to 19 and samples 101 to 106 was cooled in an environment of 25° C. for one hour. Next, as shown in FIG. 14, each of electric wires 1 according to samples 1 to 19 and samples 101 to 106 was wound five times in a direction of arrow around a wire 22 having a transverse cross section with a diameter of 0.25 mm and serving as an axis (self-diameter bending). Next, for the outer peripheral surface of the first layer of each of electric wires 1 of samples 1 to 19 and samples 101 to 106 after the self-diameter bending, a 150× SEM (Scanning Electron Microscope) image was obtained, and the outer peripheral surface of the first layer of each of electric wires 1 of samples 1 to 19 and samples 101 to 106 was evaluated in accordance with the following evaluation criteria. Obtained results are shown in the column “Evaluation Test 3” in Table 4. It should be noted that as the crystal grains are larger, a crack reaching the core wire from the crystal grain boundary is more likely to be generated. When the crack is generated in the outer peripheral surface of the first layer, it means that the detachment resistance of the coating film when stress is externally applied to the electric wire exposed to a high temperature has been decreased.

### (Evaluation Criteria for Evaluation Test 2 and Evaluation Test 3)

A′: no crack 31 was generated.

B′: crack 31 was generated.

TABLE 3

| | Core Wire | | | Second Layer | |
|---|---|---|---|---|---|
| Sample | Fe | Diameter | Stainless Steel/ | Ni | Thickness |
| No. | [Mass %] | [mm] | Carbon Steel | [Mass %] | [nm] |
| 1 | 73 | 0.15 | Stainless Steel | 99 | 0.3 |
| 2 | 73 | 0.19 | Stainless Steel | 99 | 1.1 |
| 3 | 73 | 0.19 | Stainless Steel | 99 | 1.9 |
| 4 | 73 | 0.19 | Stainless Steel | 99 | 0.6 |
| 5 | 73 | 0.16 | Stainless Steel | 99 | 10.3 |
| 6 | 99 | 0.16 | Carbon Steel | 99 | 20.8 |
| 7 | 99 | 0.17 | Carbon Steel | 99 | 5.3 |
| 8 | 99 | 0.17 | Carbon Steel | 99 | 31.1 |
| 9 | 99 | 0.17 | Carbon Steel | 99 | 28.7 |
| 10 | 99 | 0.18 | Carbon Steel | 99 | 22 |
| 11 | 99 | 0.18 | Carbon Steel | 99 | 3.6 |
| 12 | 73 | 0.17 | Stainless Steel | 99 | 40.3 |
| 13 | 73 | 0.17 | Stainless Steel | — | — |
| 14 | 73 | 0.15 | Stainless Steel | 99 | 0.3 |
| 15 | 73 | 0.19 | Stainless Steel | 99 | 11.1 |
| 16 | 73 | 0.16 | Stainless Steel | 99 | 1.9 |
| 17 | 99 | 0.17 | Carbon Steel | 99 | 33.5 |
| 18 | 99 | 0.15 | Carbon Steel | 99 | 18.3 |
| 19 | 99 | 0.19 | Carbon Steel | 99 | 40.1 |
| 101 | 73 | 0.15 | Stainless Steel | 99 | 9.7 |
| 102 | 73 | 0.15 | Stainless Steel | 99 | 15.6 |
| 103 | 99 | 0.17 | Carbon Steel | 99 | 40.2 |
| 104 | 99 | 0.17 | Carbon Steel | 99 | 5.7 |
| 105 | 99 | 0.19 | Carbon Steel | 99 | 33.6 |
| 106 | 99 | 0.19 | Carbon Steel | 99 | 21 |

TABLE 4

| | First Layer | | | | | | | | | | |
|---|---|---|---|---|---|---|---|---|---|---|---|
| | | | | | | Average | | | | | |
| | | | | | | Grain Size | | Thickness | | | |
| | | | | | | of Crystal | | of Coating | Evaluation | Evaluation | Evaluation |
| Sample | Cu | C | H | O | S | Grains | Thickness | Film | Test | Test | Test |
| No. | [Mass %] | [ppm] | [ppm] | [ppm] | [ppm] | [μm] | [mm] | [mm] | 1 | 2 | 3 |
| 1 | 99 or more | 20.5 | 0.69 | 4.15 | 0.31 | 0.8 | 0.045 | 0.045 | A | A′ | A′ |
| 2 | 99 or more | 10.5 | 1.30 | 3.34 | 0.62 | 1.2 | 0.049 | 0.049 | A | A′ | A′ |
| 3 | 99 or more | 16.5 | 0.35 | 5.62 | 0.23 | 1.5 | 0.053 | 0.053 | A | A′ | A′ |
| 4 | 99 or more | 11.5 | 1.12 | 2.41 | 0.65 | 2 | 0.041 | 0.041 | A | A′ | A′ |
| 5 | 99 or more | 15.5 | 0.51 | 5.01 | 0.22 | 0.6 | 0.04 | 0.04 | A | A′ | A′ |
| 6 | 99 or more | 12.0 | 0.94 | 3.01 | 0.55 | 0.9 | 0.06 | 0.06 | A | A′ | A′ |
| 7 | 99 or more | 14.4 | 0.67 | 4.32 | 0.25 | 0.5 | 0.059 | 0.059 | A | A′ | A′ |
| 8 | 99 or more | 12.3 | 1.22 | 3.12 | 0.45 | 0.88 | 0.048 | 0.048 | A | A′ | A′ |
| 9 | 99 or more | 15.4 | 0.41 | 5.57 | 0.29 | 0.9 | 0.055 | 0.055 | A | A′ | A′ |
| 10 | 99 or more | 12.8 | 1.03 | 2.84 | 0.53 | 1.6 | 0.057 | 0.057 | A | A′ | A′ |
| 11 | 99 or more | 14.3 | 0.62 | 4.83 | 0.28 | 1.9 | 0.043 | 0.043 | A | A′ | A′ |
| 12 | 99 or more | 13.1 | 0.88 | 3.22 | 0.42 | 0.9 | 0.045 | 0.045 | A | A′ | A′ |
| 13 | 99 or more | 13.1 | 0.88 | 3.22 | 0.42 | 0.9 | 0.045 | 0.045 | A | B′ | A′ |
| 14 | 99 or more | 19.3 | 0.32 | 4.45 | 0.54 | 0.88 | 0.045 | 0.045 | A | A′ | B′ |
| 15 | 99 or more | 9.2 | 0.44 | 6.13 | 0.28 | 1.3 | 0.043 | 0.043 | A | B′ | A′ |
| 16 | 99 or more | 16.1 | 1.24 | 3.32 | 0.73 | 0.56 | 0.058 | 0.058 | B | A′ | A′ |
| 17 | 99 or more | 9.34 | 1.37 | 5.21 | 0.44 | 1.6 | 0.041 | 0.041 | A | B′ | B′ |
| 18 | 99 or more | 21.4 | 1.11 | 2.21 | 0.39 | 0.21 | 0.045 | 0.045 | B | A′ | B′ |
| 19 | 99 or more | 13.4 | 0.98 | 1.89 | 0.13 | 4.1 | 0.052 | 0.052 | B | B′ | A′ |
| 101 | 99 or more | 22.9 | 1.31 | 5.63 | 0.71 | 2.0 | 0.044 | 0.044 | B | B′ | B′ |
| 102 | 99 or more | 26.5 | 0.34 | 2.40 | 0.13 | 1.5 | 0.053 | 0.053 | B | B′ | B′ |
| 103 | 99 or more | 10.4 | 1.44 | 6.11 | 0.09 | 1.1 | 0.055 | 0.055 | B | B′ | B′ |
| 104 | 99 or more | 9.21 | 0.17 | 0.89 | 0.32 | 0.9 | 0.049 | 0.049 | B | B′ | B′ |
| 105 | 99 or more | 1.82 | 1.53 | 0.34 | 0.78 | 0.5 | 0.059 | 0.059 | B | B′ | B′ |
| 106 | 99 or more | 7.73 | 0.26 | 1.95 | 0.82 | 0.75 | 0.055 | 0.055 | B | B′ | B' |

Each of the electric wires according to samples 1 to 19 corresponds to an example of the present disclosure, and each of the electric wires according to samples 101 to 106 corresponds to a comparative example. Based on the results of evaluation test 1, it was found that in each of the electric wires according to samples 1 to 15 and 17, the growth of the crystal grains due to the exposure to the high temperature is remarkably suppressed and a decrease in the detachment resistance of the coating film when stress is externally applied to the electric wire exposed to a high temperature was suppressed, as compared with each of the electric wires according to samples 101 to 106. Further, based on the results of evaluation tests 2 and 3, it was found that each of the electric wires according to samples 1 to 16, 18, and 19 is remarkably improved in the detachment resistance of the coating film when stress was externally applied to the electric wire exposed to a high temperature, as compared with each of the electric wires according to samples 101 to 106. Therefore, based on the results of evaluation tests 1 to 3, it was found that each of the electric wires according to samples 1 to 19 is particularly excellent in the detachment resistance of the coating film when stress is externally applied to the electric wire exposed to a high temperature, as compared with each of the electric wires according to samples 101 to 106.

In view of the above, according to each of the electric wires according to samples 1 to 19, it is possible to suppress the detachment of the coating film when stress is externally applied to the electric wire exposed to a high temperature.

Heretofore, the embodiments and examples of the present invention have been illustrated, but it has been initially expected to appropriately combine configurations of the embodiments and examples.

The embodiments disclosed herein are illustrative and non-restrictive in any respect.

The scope of the present invention is defined by the terms of the claims, rather than the embodiments described above, and is intended to include any modifications within the scope and meaning equivalent to the terms of the claims.

### REFERENCE SIGNS LIST

1 electric wire; 2 core wire; 3 second layer; 4 first layer; 5 coating film; 20a, 20b stainless steel plate; 21 arrow; 22 wire; 31 crack.

1. An electric wire comprising: a core wire; and a coating film that coats the core wire, wherein
the core wire includes iron as a main component,
the coating film includes a first layer,
the first layer includes copper as a main component, and
the first layer includes 10.5 ppm or more and 20.5 ppm or less of carbon on a mass basis.

2. The electric wire according to claim 1, wherein the first layer includes 11.5 ppm or more of the carbon on the mass basis.

3. The electric wire according to claim 1, wherein the first layer includes 16.5 ppm or less of the carbon on the mass basis.

4. The electric wire according to claim 1, wherein the first layer includes 0.35 ppm or more and 1.30 ppm or less of hydrogen on the mass basis.

5. The electric wire according to claim 4, wherein the first layer includes 0.51 ppm or more of the hydrogen on the mass basis.

6. The electric wire according to claim 4, wherein the first layer includes 1.12 ppm or less of the hydrogen on the mass basis.

7. The electric wire according to claim 1, wherein the first layer includes 2.41 ppm or more and 5.62 ppm or less of oxygen on the mass basis.

8. The electric wire according to claim 7, wherein the first layer includes 3.01 ppm or more of the oxygen on the mass basis.

9. The electric wire according to claim 7, wherein the first layer includes 5.01 ppm or less of the oxygen on the mass basis.

10. The electric wire according to claim 1, wherein the first layer includes 0.22 ppm or more and 0.65 ppm or less of sulfur on the mass basis.

11. The electric wire according to claim 1, wherein
the first layer has crystal grains, and
an average grain size of the crystal grains is 0.5 μm or more and 2 μm or less.

12. The electric wire according to claim 1, wherein
the coating film further includes a second layer,
the second layer is located between the core wire and the first layer,
the second layer includes nickel as a main component, and
a thickness of the second layer is 0.3 nm or more and 40.3 nm or less.

13. The electric wire according to claim 1, wherein a diameter of the core wire is 0.10 mm or more and 0.20 mm or less.

14. The electric wire according to claim 1, wherein a thickness of the first layer is 0.04 mm or more and 0.06 mm or less.

15. The wire according to claim 1, wherein the core wire includes stainless steel or carbon steel.
